(19) United States
(12) Patent Application Publication
(10) Pub. No.: US 2026/0240225 A1
(43) Pub. Date: Aug. 20, 2026

(54) Tobacco Article Designed to Operate with an Aerosol Generating Device, and Assembly Comprising Such Tobacco Article

(71) Applicant: JT International SA, Geneva (CH)

(72) Inventors: Jeroen Dammers, Zwolle (NL); René Van De Meeberg, Zwolle (NL)

(73) Assignee: JT International SA, Geneva (CH)

(21) Appl. No.: 18/992,800

(22) PCT Filed: Jul. 19, 2023
(86) PCT No.: PCT/EP2023/069980

§ 371 Date: Jan. 9, 2025

(30) Foreign Application Priority Data
Jul. 19, 2022 (EP) 22185817.8

(51) Int. Cl. A24D 1/20; A24D 1/00; A24D 1/02; A24F 40/20; A24F 40/465; A24F 40/51; A24F 40/65; H05B 6/10

(52) U.S. Cl. CPC A24D 1/20; A24D 1/002; A24D 1/006; A24D 1/027; A24F 40/20; A24F 40/465; A24F 40/51; A24F 40/65; H05B 6/105

(57) ABSTRACT

A tobacco article is designed to operate with an aerosol generating device and extends along an article axis between a mouth end and an upstream end. The tobacco article includes a mouth end portion defining the mouth end; a tobacco portion arranged between the upstream end and the mouth end portion; and an upstream end portion arranged adjacent to the tobacco portion and defining the upstream end of the tobacco article. The upstream end portion includes a solid stop. The solid stop includes an identification element and/or a sensor configured to provide data usable by the aerosol generating device to carry out or alter at least one of its functionalities.

### FIELD OF THE INVENTION

The present invention concerns a tobacco article designed to operate with an aerosol generating device. The tobacco article is in particular of the type to present a reduced risk for the consumer's health in comparison with conventional tobacco articles, as for example conventional cigarettes.

The present invention also relates to an assembly comprising such tobacco article and an aerosol generating device.

### BACKGROUND OF THE INVENTION

The popularity and use of reduced-risk or modified-risk devices (also known as vaporisers or aerosol generating devices) has grown rapidly in recent years as an alternative to the use of traditional tobacco products. Various devices and systems are available that heat or warm aerosol generating substances to generate an aerosol for inhalation by a user.

Aerosol generating consumable articles with a carbon-base heating source of substantially the same size as conventional cigarettes have been proposed. The source of carbon is lit as a cigarette and heats the vaporizable substrate positioned adjacent to it. These consumable articles had the advantage to be as small as conventional cigarettes and to be easy to handle when vaping. However, burning solid fragments or parts (e.g. charcoal) had a tendency to dissociate from the rest of the consumable thereby creating burning risks for the consumer. Therefore, these consumable articles did not reach so far significant commercial success.

One more recent type of commonly available reduced-risk or modified-risk device is the heated substrate aerosol generating device, or so-called heat-not-burn device (or HNB device). Devices of this type generate an aerosol or vapour by heating an aerosol generating substrate to a temperature typically in the range 150° C. to 350° C. Heating the aerosol generating substrate to a temperature within this range, without burning or combusting the aerosol generating substrate, generates a vapour which typically cools and condenses to form an aerosol for inhalation by a user of the device.

Some devices of this type can operate with tobacco articles, having for example an elongated shape which can resemble the external shape of a conventional cigarette. Such tobacco articles may comprise a tobacco portion and a mouth end portion. The tobacco portion contains generally an aerosol generating substrate and is designed to be received inside the device, in particular so as to be heated by a heating system. The mouth end portion can protrude from the device and is designed to cooperate with the user's lips and/or mouth. There is available a large number of different types of tobacco articles, having for example different types of aerosol generating substrates, specific mouth end portions, specific filters, etc.

In some cases, it may be possible for a user to insert a tobacco article, which is not adapted for the device it is inserted in. In such case, for example operation of the device together with the tobacco article may be altered and user experience may not always be optimal.

In addition, functionalities of the aerosol generating device may depend on different characteristics or data regarding the tobacco article. In order to improve user experience, it may be desirable to obtain a large amount of such data and/or to be able for the device to differentiate the tobacco article from other tobacco articles.

### SUMMARY OF THE INVENTION

One of the aims of the invention is to provide a tobacco article providing an improved user experience, in particular when being used with a given aerosol generating device.

For this purpose, the invention relates to a tobacco article designed to operate with an aerosol generating device and extending along an article axis between a mouth end and an upstream end, and comprising:
a mouth end portion defining the mouth end;
a tobacco portion between the upstream end and the mouth end portion;
a upstream end portion arranged adjacent to the tobacco portion and defining the upstream end of the article;
the upstream end portion comprising a solid stop extending transversally in respect with the article axis;
the solid stop comprising an identification element and/or a sensor configured to provide data usable by the aerosol generating device to carry out or alter at least one of its functionalities.

According to these features, the tobacco article provides an improved user experience, in particular when being used with a given aerosol generating device. Particularly, the tobacco article according to the invention allows transmitting data or information to the aerosol generating device, for example in an active or passive way. This allows for example for the aerosol generating device to adapt operation based on the data or information obtained from the tobacco article.

For example, the identification element allows transmitting, in an active or passive way, to the aerosol generating device, an identification information regarding the tobacco article, such as for example a type of tobacco article, a producer of the tobacco article, a batch number of the tobacco article or specific feature of the tobacco article. The identification element may for example allow preventing operation of the device with third party tobacco articles or counterfeit tobacco articles, which may not provide optimum user experience.

The functionalities of the device may encompass heating, activating or deactivating a mode (e.g., switching on/off, saving mode, etc.), providing signals or alerts (such as light, haptic, or sound signals or alerts), setting up a vaping mode, programming, disabling a program, indicating information (e.g. battery charging level, number of puffs) and any combination thereof.

The sensor can improve user experience as one or several of the functionalities can be carried out by using data from the sensor. For example, a heating operation may be controlled based on data received from the sensor, such as temperature or pressure data. As the sensor is a part of the solid stop of the tobacco article, for example temperature data of the sensor may provide particularly precise information regarding tobacco in the tobacco portion arranged for example adjacent to the upstream end portion.

Furthermore, the combination of the solid stop comprising both an identification element and a sensor improves user comfort and user experience when consuming the tobacco article. For example, thanks to this combination of identification element and sensor, it may be possible to identify a specific type of tobacco article, and then control operation of the aerosol generating device, such as heating, so that the sensor data matches target values specifically defined for the identified type of tobacco article.

Also, the arrangement of the identification element and/or the sensor in the portion defining the upstream end of the article, allows good identification as this portion may be inserted at first into the aerosol generating device. For example, the upstream end of the article may be inserted into a cavity of the aerosol generating device such that, in the inserted position, the upstream end portion of the tobacco article may be arranged at an inner end of the cavity, allowing reliable identification or data transmission between the article and the aerosol generating device. For example, data from the sensor can be transmitted to the aerosol generating device in a reliable manner in this position, as the tobacco article is secured in a predetermined position with respect to the device and in a position that is protected from the external environment.

In some embodiments, the or each identification element extends transversally with respect to the article axis, advantageously without being in contact with a lateral face and/or an outer face of the solid stop. For example, the identification element may be moulded inside the solid step and/or wrapped by a front wrapper or be slightly inserted in transversal position inside the filling of the solid stop.

As used herein, the term “vaporizable material” or “aerosol-forming precursor” or “aerosol material” may refer to one or more of a: liquid; solid; gel; mousse; foam or other substances. The vaporizable material may be heated to form an aerosol as defined below. The vaporizable material may comprise one or more of: nicotine; caffeine or other active components. The active component may be carried by a carrier, which may be a liquid. The carrier may comprise an aerosol former such as polyols. In some embodiments, the aerosol former comprises one or more of polyhydric alcohols, such as propylene glycol, 1,3-butanediol and glycerin, ester of polyhydric alcohols, such as glycerol mono-, di- or triacetate; and/or aliphatic esters of mono-, di- or poly-carboxylic acids, triethyl citrate (TEC), or triacetin. A preferred carrier may be propylene glycol and/or glycerin. The carrier is vaporized upon heating, generally at a temperature of about 350° C. or lower. A flavoring may also be present. The flavoring refers to substances which may be sued to create a desired taste or aroma. They may include naturally occurring flavor materials, botanicals, extracts of botanicals, synthetically obtained flavoring substances, or combinations thereof. The flavoring may include, e.g. Ethylvanillin (vanilla), menthol, berry, Isoamyl acetate (banana oil), eugenol, cooling agent (e.g., eucalyptol, WS-5 or WS-3) or similar. A solid aerosol forming substance may be in the form of a rod, which contains processed tobacco material, a crimped sheet or oriented strips or shreds of reconstituted tobacco (RTB).

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the vaporizable material.

The aerosol generating device can be portable and can be carried together with the tobacco article by the user, when the tobacco article is not used to generate vapor. The aerosol generating device may form in particular an HNB device. Particularly, it can comprise a battery and a heater and/or a heating element.

The tobacco article can be designed for a single use or multiple uses. In the first case, it can be discarded or recycled after the use. In the second case, it is possible to make it last through several vaping sessions. The consumable article may be formed by a cigarette known in the art for example for using with HNB devices.

According to some embodiments, the solid stop is air impermeable according to the article axis.

According to some embodiments, the solid stop prevents or at least reduces air flow through the upstream portion in the direction of the article axis.

According to some embodiments, the upstream end portion is air impermeable according to the article axis. In particular, the solid stop may extend over the whole section of the upstream end portion, transversally to the article axis.

Thanks to these features, an incoming airflow is forced through a predefined way into the tobacco portion, such as for example via additional perforations, as the solid stop extending transversally in respect with the article axis is air impermeable. This allows providing a more versatile tobacco article, as for example an external face of an end of the upstream end portion may be used for functionalities other than air inlet.

According to some embodiments, the solid stop delimits at least one airflow channel defining an airflow outlet opening to the tobacco portion.

Thanks to these features, the solid stop allows providing an airflow into the tobacco portion, so as to obtain optimal generation of aerosol in the tobacco portion.

According to some embodiments, the tobacco article comprises an absorbent material configured for absorbing at least partially aerosol from air comprising aerosol.

According to some embodiments, the airflow outlet is arranged on a contacting face of the solid stop, said contacting face being in contact with the tobacco portion and extending transversally in respect with the article axis.

Thanks to these features, the airflow outlet allows good penetration of the tobacco portion by air, when an airflow traverses the contacting face.

According to some embodiments, the or each airflow channel defines at least one airflow inlet arranged on a lateral face of the solid stop, said lateral face extending according to the article axis.

Thanks to these features, an airflow is forced through the at least one airflow inlet arranged on a lateral face of the solid stop. This allows providing a more versatile tobacco article, as for example an external face of an end of the upstream end portion may be used for functionalities other than air inlet. Also, thanks to these features, the tobacco article may be designed to operate with an aerosol generating device which is particularly compact, as air may be received with the lateral face of the tobacco article.

According to some embodiments, the or each airflow channel defines a plurality of airflow inlets arranged circumferentially on the lateral face of the solid stop.

Thanks to these features, the tobacco article allows receiving a large amount of air, and enables operation with a very compact aerosol generating device at the same time.

According to some embodiments, the tobacco article further comprises a wrapper wrapping at least the tobacco portion and extending around the article axis.

Thanks to these features, at least the tobacco portion is protected. In addition, the wrapper provides high user comfort for a user manipulating the tobacco article.

According to some embodiments, the wrapper defines at least one airflow inlet opening to the tobacco portion.

Thanks to these features, the tobacco article allows receiving air via at least one predefined opening, and allows thus efficient penetration of air into the tobacco portion.

According to some embodiments, the wrapper defines a plurality of airflow inlets arranged circumferentially and opening to the tobacco portion.

Thanks to these features, the tobacco article allows receiving a large amount of air in the tobacco portion.

According to some embodiments, the wrapper wraps the tobacco portion and the upstream end portion together.

Thanks to these features, the tobacco article is particularly compact and its manufacturing is simple. For example, it may not be required to provide any additional attachment means between the tobacco portion and the upstream end portion. Also, the upstream end portion may be arranged directly in contact with the tobacco portion, which allows obtaining a tobacco article which is very compact.

According to some embodiments, the solid stop comprises an identification element configured to provide identification data and/or authentication data relative to the tobacco article.

Thanks to these features, the tobacco article allows providing a specific identification or authentication of the tobacco article to the aerosol generating device, when the tobacco article is inserted into the aerosol generating device. This allows for example to guarantee that only predefined tobacco articles are used with the device. The authentication data allows for example detecting tobacco articles of an unauthorized manufacturer or seller.

According to some embodiments, the identification element is arranged on an external face of the solid stop, the external face extending transversally in respect with the article axis.

Thanks to these features, identification of the tobacco article is particularly easy, for example for a user when the article is not yet inserted into the aerosol generating device. Also, identification of the tobacco article is particularly easy for the device, having for example means for detecting the identification element, once the tobacco article is inserted into the device.

According to some embodiments, the identification element corresponds to at least one of the following elements:
antenna/spool;
RFID tag;
optical code;
flat symbol;
embossed symbol.

Thanks to these features, the identification element may comprise specific data depending on the application. Also, thanks to these features, the amount and type of data comprised in the identification element may be adapted easily.

According to some embodiments, the tobacco portion further comprises a heating element, notably a susceptor, arranged in contact with or traversing the solid stop.

Thanks to these features, the tobacco article can be heated easily when receiving energy, and tobacco in the tobacco portion may be heated directly.

According to some embodiments, the solid stop comprises a temperature sensor configured to provide temperature measurements of least a part of the tobacco portion.

Thanks to these features, operation of the aerosol generating device together with the tobacco article may be improved, as for example heating may be adapted based on the temperature measurements.

The invention also relates to an assembly comprising a tobacco article as described above, and an aerosol generating device delimiting a cavity configured for receiving the tobacco article.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic cross-sectional view of a tobacco article according to a first embodiment of the invention, according to a first plane I extending along an article axis of the tobacco article;

FIG. 2 is a schematic view of an outer face of the tobacco article of FIG. 1 showing a wrapper of the tobacco article;

FIG. 3 is a schematic cross-sectional view of an assembly comprising the tobacco article of FIG. 1 according to the first plane I, and an aerosol generating device;

FIGS. 4 to 7 are schematic views of different examples of a solid stop of the tobacco article of FIG. 1, according to a second plane Il perpendicular to the first plane I;

FIG. 8 is a schematic cross-sectional view similar to the view of FIG. 3 of an assembly comprising a tobacco article and an aerosol generating device according to a second embodiment of the invention;

FIG. 9 is a schematic cross-sectional view of a tobacco article similar to the view of FIG. 1, according to a third embodiment of the invention;

FIG. 10 is a schematic view of an outer face of the tobacco article of FIG. 9 showing a wrapper of the tobacco article, and

FIG. 11 is a schematic cross-sectional view of a tobacco article similar to the view of FIG. 9, according to an alternative example of the third embodiment of the invention.

### DETAILED DESCRIPTION

### First Embodiment of the Invention

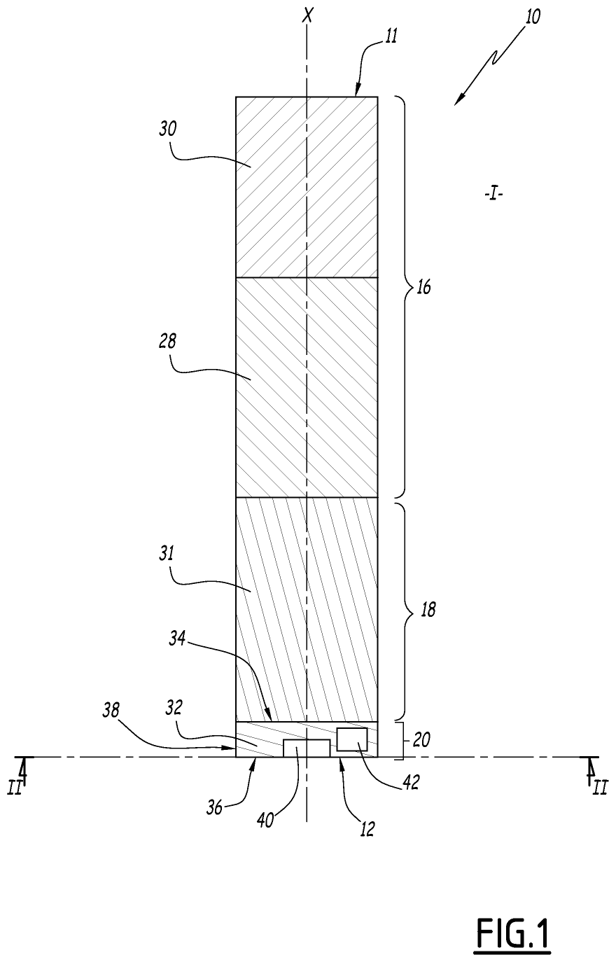

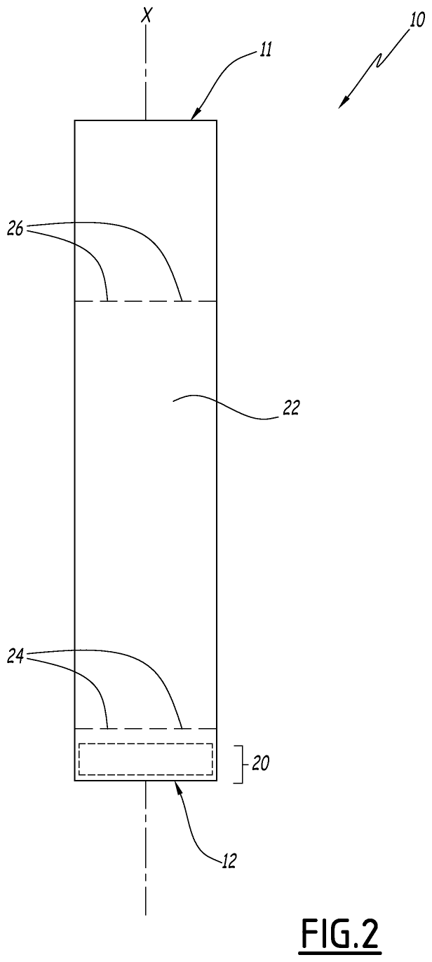

A tobacco article 10 according to a first embodiment of the invention is shown in FIGS. 1 and 2. The tobacco article 10 extends along an article axis X between a mouth end 11 and an upstream end 12.

The tobacco article 10 may have a generally cylindrical shape. This cylindrical shape is circular in cross-sections perpendicular to the article axis X, forming in particular circles of a constant radius. Advantageously, the tobacco article 10 has a shape and/or dimensions which are substantially equal to those of a conventional cigarette or an HNB article (heat-not-burn article). However, in some alternative embodiments, the tobacco article 10 may have other handy shapes than a conventional cigarette, such as parallelepipedal type, pebble type shape, etc. The tobacco article 10 may also be of larger size (e.g. in longitudinal or circumferential direction) than a conventional cigarette without it being detrimental to the way it is handled and consumed by the user.

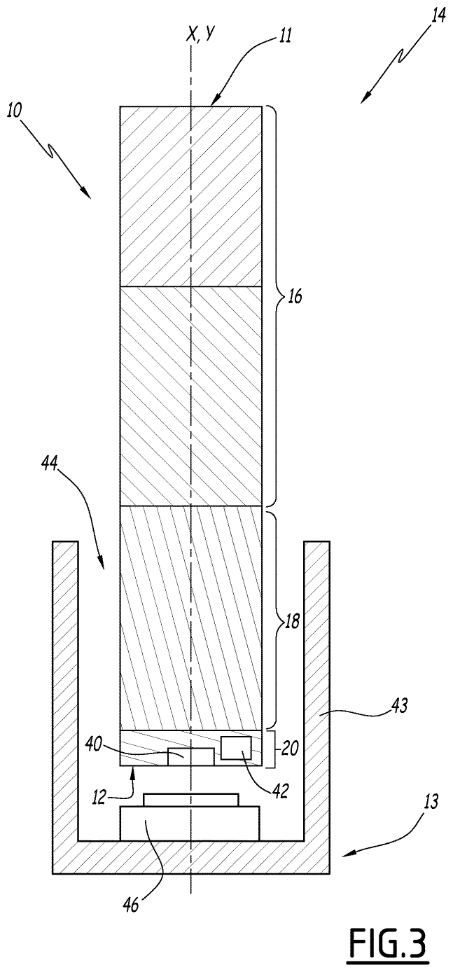

With reference to FIG. 3, the tobacco article 10 is designed to operate with an aerosol generating device 13, so as to form an assembly 14. In the example of FIG. 3, the tobacco article 10 is inserted partially into the aerosol generating device 13 along a device axis Y. The device axis Y may be identical to the article axis X. An inserted position of the tobacco article 10 may be defined in a position in which the upstream end 12 is in contact with at least one part of the aerosol generating device 13, as described in further detail below.

Referring again to FIG. 1, this Figure shows a cross section of the tobacco article 10 according to a first plane I extending along the article axis X. The tobacco article 10 comprises a mouth end portion 16 defining the mouth end 11, notably designed to be in contact with the user's mouth/lips, a tobacco portion 18 arranged between the upstream end 12 and the mouth end portion 16 and an upstream end portion 20 arranged adjacent to the tobacco portion 18 and defining the upstream end 12 of the tobacco article 10. In particular, the mouth end portion 16, the tobacco portion 18, and the upstream end portion 20 are arranged in this order along the article axis X. According to examples, the tobacco portion 18 is arranged adjacent, in particular directly adjacent, to the mouth end portion 16.

With reference to FIG. 2, the tobacco article 10 may further comprise a wrapper 22 extending around the article axis X. The wrapper 22 may for example comprise paper, aluminium foil or combinations thereof. According to examples, the wrapper 22 may wrap at least the tobacco portion 18, i.e. may extend on an outer surface of the tobacco portion 18 around the article axis X. For example, the wrapper 22 may wrap together the tobacco portion 18 and the upstream end portion 20. According to an example, the wrapper 22 may wrap together, in addition, the mouth end portion 16 to the tobacco portion 18. In particular, the wrapper 22 may hold the portions 18 and 20, and optionally 16, together so that no additional fixing means are arranged between the respective portions.

In FIG. 2, the upstream end portion 20 is represented with dotted lines so as to show that this portion is covered by the wrapper 22 in this view.

According to the example of FIG. 2, the wrapper 22 may define at least one airflow inlet 24 opening to the tobacco portion 18. The or each airflow inlet 24 may be formed by a perforation of the wrapper 22. Advantageously, the wrapper 22 defines a plurality of airflow inlets 24 arranged circumferentially and opening to the tobacco portion 18. As illustrated in the example of FIG. 2, each airflow inlet 24 may have substantially an identical shape, and/or be arranged in a same distance to an adjacent airflow inlet 24 along a circumferential direction around the article axis X.

The wrapper 22 may furthermore define cooling airflow inlets 26 opening into the mouth end portion 16 so as to allow cooling of an airflow charged with aerosols from the tobacco portion 18, by mixing this airflow with cooler air received in the mouth end portion 16 via the cooling airflow inlets 26. In particular, the cooling airflow inlets 26 may open into a cooling part, described below, of the mouth end portion 16. Each cooling airflow inlet 26 may for example have substantially an identical shape. For example, each cooling airflow inlet 26 may be arranged in a same distance to an adjacent cooling airflow inlet 26 along a circumferential direction around the article axis X. For example, each cooling airflow inlet 26 may have the same shape and dimensions as each airflow inlet 24. In some other embodiments, each cooling airflow inlet 26 may have smaller dimensions than each airflow inlet 24.

In the example of FIG. 1, the mouth end portion 16 comprises a cooling part 28 extending along the article axis X, and a filter part 30 extending along the article axis X, in particular between the cooling part 28 and the mouth end 11. The cooling part 28 may be designed to cool an airflow comprising aerosol formed in the tobacco portion 18 further to its heating. For example, the cooling part 28 may be formed by at least one hollow tubular element (e.g. paper tube). The filter part 30 may have an end forming the mouth end 11, and an opposite end facing the cooling part 28. The filter part 30 may comprise one or several filter(s) configured to filter the aerosol formed in the tobacco portion 18.

In some embodiments, no cooling part 28 and/or no filter part 30 is provided. For example, the mouth end portion 16 may be formed by an end of the tobacco portion 18 defining the mouth end 11 in this case. In addition, in this case, an exchangeable filter/cooler mouthpiece can be used which can be connected to the tobacco article 10.

The tobacco portion 18 also extends along the article axis X and can for example be shorter than the mouth end portion 16. According to another example, the tobacco portion 18 has the same length as the mouth end portion 16 or is longer than this mouth end portion 16.

The tobacco portion 18 may contain a vaporizable material 31 as defined above.

The upstream end portion 20 comprises a solid stop 32 extending transversally in respect with the article axis X. In other words, the solid stop 32 extends in a direction perpendicular to the article axis X.

The solid stop 32 may comprise for example a polymer material, preferably biodegradable, and/or a moulded cellulose pulp material. Preferably, all parts of the solid stop 32, except the identification element 40 (described below) and/or the sensor 42 (described below) may consist of such material.

The solid stop 32 may for example have a cylindrical shape having a symmetry axis identical to the article axis X. According to an example, the solid stop 32 can have a contacting face 34 extending transversally in respect with the article axis X, an external face 36 also extending transversally in respect with the article axis X, and a lateral face 38 extending according to the article axis X, in particular parallel to the article axis X and perpendicular to the contacting face 34 and/or the external face 36. The contacting face 34 may in particular be in contact with the tobacco portion 18, whereas the external face 36 may form the upstream end 12 of the tobacco article 10. The lateral face 38 may connect the contacting face 34 and the external face 36 and present a circular cross section in a second plane II, visible in particular in FIG. 1, perpendicular to the article axis X.

The solid stop 32 may be air impermeable according to the article axis X. By “air impermeable according to the article axis”, it is in particular understood that the solid stop 32 prevents any air passage along a direction parallel to the article axis X trough the solid stop 32. In particular, it is understood that the solid stop 32 prevents air to pass from the external face 36 to the contacting face 34 and vice-versa.

According to the first embodiment, the solid stop 32 may also be air impermeable according to a direction perpendicular to the article axis X. In other words, the solid stop 32 may prevent any air to enter the solid stop 32 through the lateral face 38 according to the first embodiment.

According to an example, each of the contacting face 34, the external face 36 and the lateral face 38 may form surfaces, which are closed and in particular prevent any air to pass into an inner volume of the solid stop 32.

For example, the solid stop 32 may be formed in one piece, in particular of a homogenous material.

According to the invention, the solid stop 32 comprises an identification element 40 and/or a sensor 42 configured to provide data usable by the aerosol generating device to carry out or alter at least one of its functionalities.

According to embodiments, the solid stop 32 may comprise one or several identification elements 40. The or each identification element 40 may be arranged on the external face 36 of the solid stop 32. According to another example, the or each identification element 40 integrated inside the solid stop 32, and in particular without contact to the contacting face 34, the outer face 36 and the lateral face 38. In this case, the or each identification element 40 can extend transversally with respect to the article axis X without contact to the lateral face 38 and/or to the outer face 36. For example, the identification element 40 may be moulded inside the solid step 32 and/or wrapped by a front wrapper or be slightly inserted in transversal position inside the filling of the solid stop 32.

The or each identification element 40 may be configured to provide identification data relative to the tobacco article 10. The identification data may comprise for example a type of tobacco article 10, a producer name or identifier of the tobacco article 10, a batch or serial number of the tobacco article 10 or specific feature of the tobacco article 10.

According to an example, the or each identification element 40 may be configured to provide authentication data relative to the tobacco article 10. The authentication data may for example comprise same or similar data as the identification data. According to an example, the authentication data may be encrypted.

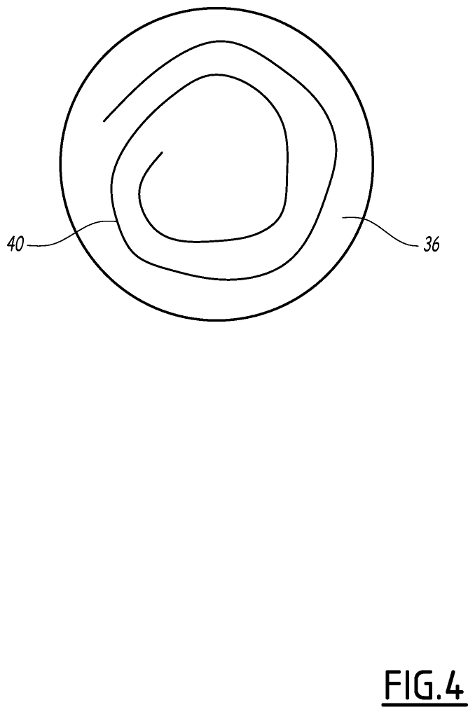

Examples of the identification element 40 are shown in FIGS. 4 to 7.

With reference to FIG. 4, the identification element 40 may comprise an antenna or spool adapted to send data by wireless data transmission to the aerosol generating device 13. In this case, the identification element 40 may also comprise a control circuit (not shown). For example, the antenna or spool may be a passive element, being activated for data transmission upon reception of a trigger signal and/or corresponding wireless energy transmission from the aerosol generating device 13. According to another example, the antenna or spool may be an active element, configured to emit data further to a command of the control circuit.

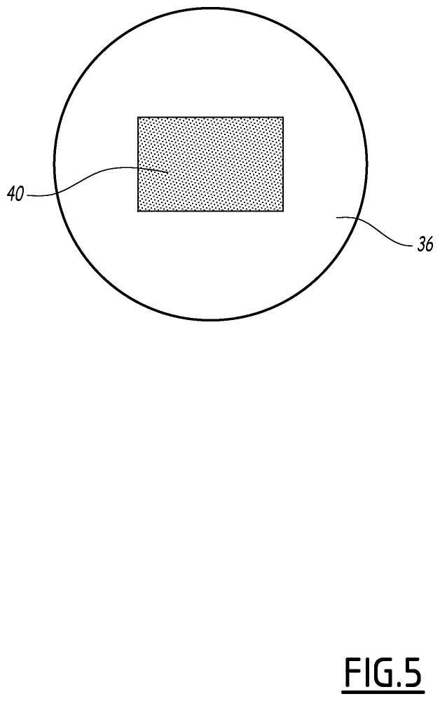

With reference to FIG. 5, the identification element 40 may comprise an RFID tag (from “Radio-Frequency IDentification tag”) arranged on the external face 36 or inside the solid stop 36. The RFID tag may be adapted to emit the identification or authentication data to the aerosol generating device 13 by wireless data transmission. The RFID tag may be an active or passage tag, as known as such.

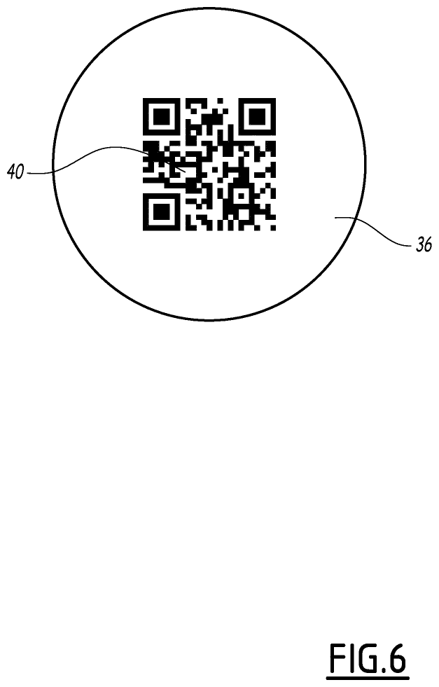

With reference to FIG. 6, the identification element 40 may comprise an optical code, such as a QR code (from “Quick Response code”). The optical code may be adapted to be read from a corresponding camera of the aerosol generating device 13 so as to obtain the identification and/or authentication data.

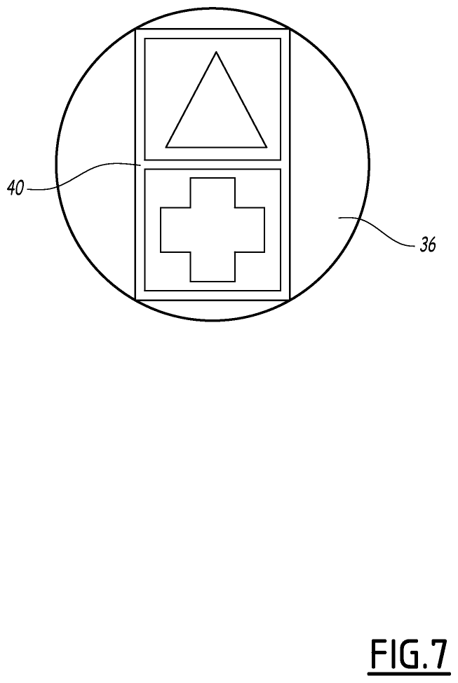

With reference to FIG. 7, the identification element 40 may comprise a shape, such as a cross, a triangle, a circle, any combination thereof or any other predefined geometrical shape. The shape may be adapted to be detected by a detector or camera of the aerosol generating device 13. Advantageously, the shape may be arranged on the external face 36 of the solid stop 32. According to another example, the shape may be arranged on the lateral face 38. In this case, no wrapper 22 may be present on the lateral face 38.

The identification element 40 may be for example a flat symbol or an embossed symbol, in particular arranged on the external face 36 of the solid stop 32. The flat symbol or embossed symbol may have the form of the shape or of the optical code. The flat symbol may for example be a symbol having at least one colour different from a background colour. The embossed symbol may be for example a protrusion from the external face 36, extending in at least one plane parallel to the external face 36. According to an example, the identification element 40 may be an embossed symbol having different colours, for example on part of the embossed symbol only, so as to provide additional identification or authentication data.

The sensor 42 of the solid stop 32 may be moulded into the solid stop 32 or arranged on a face of the solid stop 32, such as the contacting face 34 or on the external face 36.

The sensor 42 may be a temperature sensor configured to provide temperature measurements of least a part of the tobacco portion 18. In this case, the sensor 42 may be arranged on or close to the contacting face 34 so as to provide temperature measurements of the vaporizable material 31. According to another example, the sensor 42 may be a pressure sensor, for example arranged adjacent to the tobacco portion 18. The pressure sensor may be configured to detect a puff by the user for example.

The sensor 42 may be connected to a transmission module (not shown) configured to transmit data of the measurements, such as temperature or pressure measurements, to the aerosol generating device 13, for example so as to allow heating control in function of these data. In some embodiments, the transmission module is implemented according to one or several technologies explained in relation with the identification element 40. For example, the transmission module can comprise an antenna or an RFID tag as explained above.

Referring again to FIG. 3, the aerosol generating device 13 may be a HNB (heat-not-burn) device. The aerosol generating device 13 may have a housing 43 forming a cavity 44 configured for receiving at least partially the tobacco article 10. In the example of FIG. 3, the tobacco article 10 is partially received in the cavity 44. Particularly, the cavity 44 is adapted to receive entirely the tobacco portion 18 when the solid stop 32 enters in contact with a bottom of the cavity 44. Advantageously, the total length of the tobacco portion 18 and the upstream end portion 20 is substantially equal to the length, along the device axis Y, of the cavity 44.

The cross-sectional shape of the cavity 44 corresponds for example to the cross-sectional shape of the tobacco article 10. In this case, the aerosol generating device 13 may further comprise anchoring means (not shown) designed to fix the tobacco article 10 in a desired position in respect for example with the cavity 44. According to one example, the anchoring means comprise protruding surfaces designed to protrude radially in the interior part of the cavity 44 to fix the tobacco article 10 by friction. According to another example, the anchoring means comprise a needle or blade designed to protrude from the cavity 44 and penetrate the tobacco article 10 to fix it in the engaged position.

According to another example, no anchoring means are provided. In this case, the cross-section of the cavity 44 can be slightly smaller than the cross-section of the tobacco article 10 so as to compress and fix it in the cavity 44.

The housing 43 comprises various internal components (not shown) of the device 13 ensuring its various functionalities. For example, the housing 43 comprises one or several heating element(s), a controller to control the operation of the heating element(s) and a battery to power the heating element(s) and the controller.

The battery is for example a known battery designed to be charged using the power supply furnished by an external source and to provide a direct current of a predetermined voltage. The battery can be associated to a battery charger which is able to connect it to the external source and comprises for this purpose a power connector (like for example a mini-USB or USB-C connector) or wireless charging connector.

The controller is configured to control the operation of the heating element(s) by controlling its powering by the battery. For this purpose, the controller is for example able to apply a predetermined heating profile to control the operation of the heating element(s). In some embodiments, the heating profile may be chosen depending on data obtained from the identification element 40 and/or from the sensor 42. For instance, if the authentication data relative to the tobacco article 10 of the identification element 40 indicates that the article 10 is a product of a non-authorized manufacturer, the user may be warned and/or the controller may prevent heating of the heating element(s). According to another example, the heating profile can be adapted based on temperature or other type of measurements provided by the sensor 42.

The or each heating element can comprise for example a resistive element designed to convert electrical energy to heat and/or a magnetic element designed to generate a magnetic field around the heating element(s). According to an example, the assembly 14 comprises a susceptor, and each heating element comprises a magnetic element like a magnetic coil. In this case, each heating element is for example adapted to generate a magnetic field according to the whole length of each heating element which heats the tobacco portion 18 and in particular the vaporizable material 31 contained therein.

According to the first embodiment, the aerosol generating device 13 may comprise a detector 46. The detector 46 may be arranged at the bottom of the cavity 44, as illustrated as an example in FIG. 3. According to an alternative, the detector 46 may be arranged on a lateral wall of the housing 43.

The detector 46 may be configured to detect the identification element 40, and in particular the identification and/or authentication data relative to the tobacco article 10. For example, the detector may be a camera or another an electromagnetic receiver or an antenna.

According to examples, the detector 46 may be configured to receive the data from the sensor 42 of the tobacco article 10, and for example send these data to the controller of the device 13 so that the device is able to carry out or alter at least one of its functionalities in function of the data. The functionalities carried out or being altered may comprise for example heating, activating or deactivating a mode (e.g. switching on/off, saving mode, etc.), providing signals or alerts (such as light, haptic, sound signals or alerts), setting up a vaping mode, programming, disabling a program, etc.

### Second Embodiment of the Invention

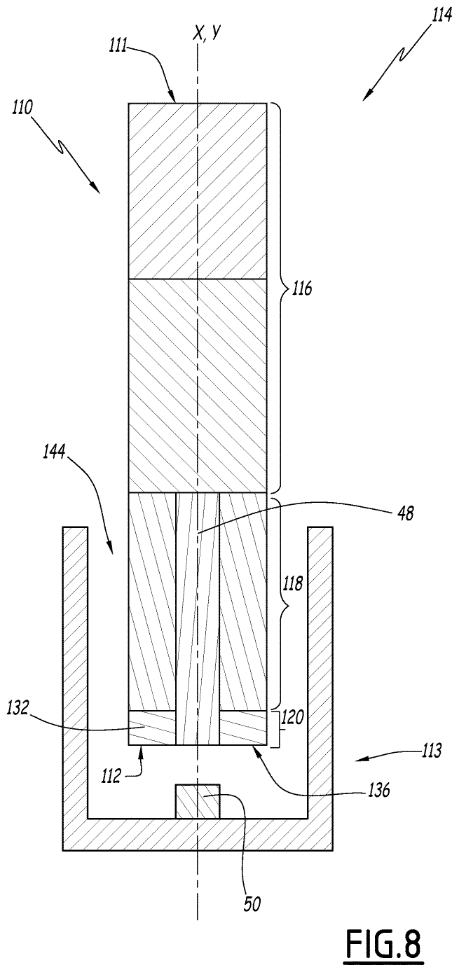

A second embodiment of the invention is now described with reference to FIG. 8. The corresponding elements of the second embodiment compared with the first embodiment comprise the same reference signs, increased by 100. Some elements are omitted in FIG. 8 compared to the first embodiment of the assembly 14. However the assembly 114 according to the second embodiment may also comprise one, several or all of the elements of the assembly 14.

In the following, in particular the differences of the second embodiment compared with the first embodiment are described. The same or corresponding elements are not described again.

The tobacco portion 118 may comprise a heating element 48 arranged in contact with the solid stop 132. The heating element 48 may for example be a susceptor. The heating element may be arranged in contact with the solid stop 132. The heating element 48 may for example extend according to the article axis X through at least a part of the tobacco portion 118 and at least a part of the upstream end portion 120. With reference to FIG. 8, the heating element 48 may extend through the whole length of the tobacco portion 118 and the upstream end portion 120 along the article axis X. For example, part of the external face 136 may be formed by an end of the heating element 48. In particular, the solid stop 132 may comprise a hole receiving part of the heating element 48. In this case, the solid stop 132 is advantageously air impermeable according to the article axis X when the heating element 48 is inserted into the solid stop 132.

The aerosol generating device 13 according to the second embodiment may comprise for example a heat generator 50, such as a magnetic coil, configured to produce a magnetic field which heats the heating element 48, i.e. the susceptor, and thus the tobacco portion 18.

According to an example, the aerosol generating device 113 may comprise a sensor (not shown), such as a temperature sensor, arranged in the cavity 144, and being configured to measure the temperature of the heating element 48, such as the susceptor, advantageously by contactless measurement. In addition or according to an alternative example, the tobacco article 110 may comprise the sensor in the solid stop 132 forming a temperature sensor.

The solid stop 132 according to the second embodiment may also comprise the identification element and/or the sensor configured to provide data usable by the aerosol generating device 113 to carry out or alter at least one of its functionalities. The identification element and/or the sensor is/are identical or similar to those described in the first embodiment of the invention. In particular, the solid stop 132 may provide the same or similar functionalities as the solid stop 32 according to the first embodiment.

### Third Embodiment of the Invention

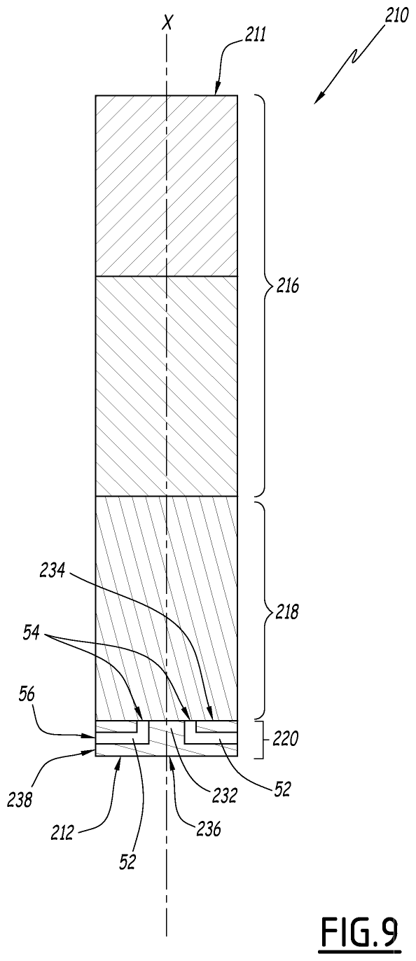

A third embodiment of the invention is now described with reference to FIG. 9. The corresponding elements of the third embodiment compared with the first embodiment comprise the same reference signs, increased by 200. Some elements are omitted in FIG. 9 compared to the first embodiment of the tobacco article 10. However, the tobacco article 210 according to the third embodiment may also comprise one, several or all of the elements of the tobacco article 10.

In FIG. 9, only the tobacco article 210 is shown, and the aerosol generating device is omitted. The tobacco article 210 is designed to operate with an aerosol generating device 13, 113 according to the first or second embodiment having the features as described above.

In the following, in particular the differences of the third embodiment compared with the first embodiment are described. The same or corresponding elements are not described again.

The upstream end portion 220 of the third embodiment may comprise a solid stop 232 delimiting an airflow channel 52. The airflow channel 52 may define an airflow outlet 54 opening to the tobacco portion 218. The airflow outlet 54 may be for example arranged on the contacting face 234 of the solid stop 232. The contacting face 234 is in particular arranged in the same position and orientation as the contacting face 34 of the first embodiment. In particular, the contacting face 234 may be in contact with the tobacco portion 218 and extend transversally in respect with the article axis X. The airflow channel 52 may define at least one airflow inlet 56 arranged on the lateral face 238 of the solid stop 232. The lateral face 238 is in particular arranged in the same position and orientation as the lateral face 38 of the first embodiment, i.e. extending according to the article axis X.

According to an example, the airflow channel 52 may present, in particular in the first plane I comprising the article axis X, a curve having an angle substantially equal to 90 degrees. For example, a flow direction at the airflow inlet 56 may be substantially perpendicular to a flow direction at the airflow outlet 54. For example, the airflow channel 52 may present, in the first plane I, an L form.

According to an example, the airflow channel 52 may define a plurality of airflow inlets 56 arranged circumferentially on the lateral face 238 of the solid stop 232. For example, each airflow inlet 56 may have the same shape and/or the same distance to an adjacent airflow inlet 56.

According to an example, the solid stop 232 may comprise a plurality of airflow channels 52 as described above. For example, each airflow channel 52 may comprise a single airflow inlet 56 and a single airflow outlet 54. In this case, the airflow inlet 56 of each airflow channel 52 may have the same shape and/or the same distance to an adjacent airflow inlet 56. According to another example, each airflow channel 52 may comprise a plurality of airflow inlets 56 and/or airflow outlets 54.

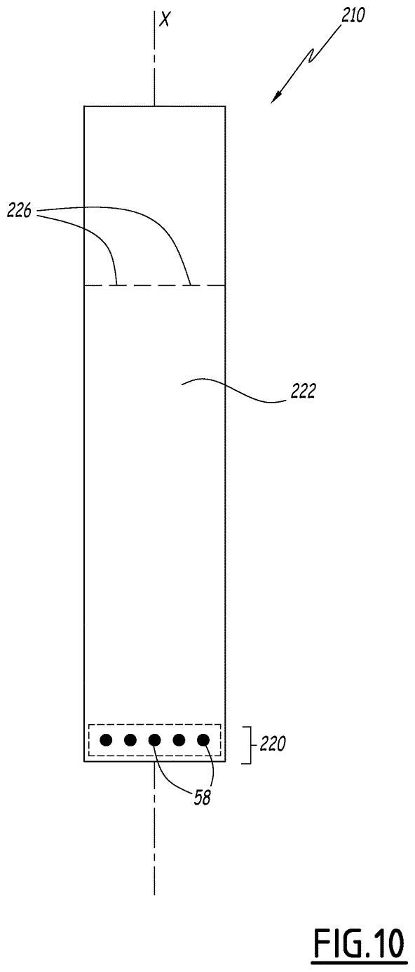

With reference to FIG. 10, the tobacco article 210 comprises a wrapper 222. The wrapper 222 may define the same or similar cooling airflow inlets 226 as the cooling airflow inlets 26 of the first embodiment. The wrapper 222 according to the third embodiment may comprise at least one, preferably several end airflow inlets 58. Each end airflow inlets 58 may be arranged to face the corresponding airflow inlet 56 of the solid stop 232. For example, each end airflow inlet 58 may present the same shape as the corresponding airflow inlet 56. As visible in an example of FIG. 10, the wrapper 222 may define a plurality of the end airflow inlet 58 arranged circumferentially around the article axis X. Preferably, each end airflow inlet 58 presents a same distance to a neighbouring end airflow inlet 58. In addition, the wrapper 222 may comprise one or several airflow inlets (not shown) opening into the tobacco portion 18. This or these airflow inlet(s) are identical to the airflow inlet(s) 24 of the first embodiment.

In FIG. 10, the upstream end portion 220 is represented with dotted lines so as to show that this portion is covered by the wrapper 222 in this view.

The solid stop 232 according to the third embodiment may also comprise the identification element and/or the sensor configured to provide data usable by the aerosol generating device to carry out or alter at least one of its functionalities. The identification element and/or the sensor is/are identical or similar as described in the first embodiment of the invention. In particular, the solid stop 232 may provide the same or similar functionalities as the solid stop 32 according to the first embodiment.

The solid stop 232 according to the third embodiment, having one or several airflow channel(s) 52 may be combined with the tobacco article 10, 110 of the first or second embodiment. Also, solid stop 232 of the third embodiment may be adapted so that it comprises a hole for receiving the heating element 48 of the second embodiment.

Also, the wrapper 222 according to the third embodiment may be combined with the tobacco article 10, 110 of the first or second embodiment.

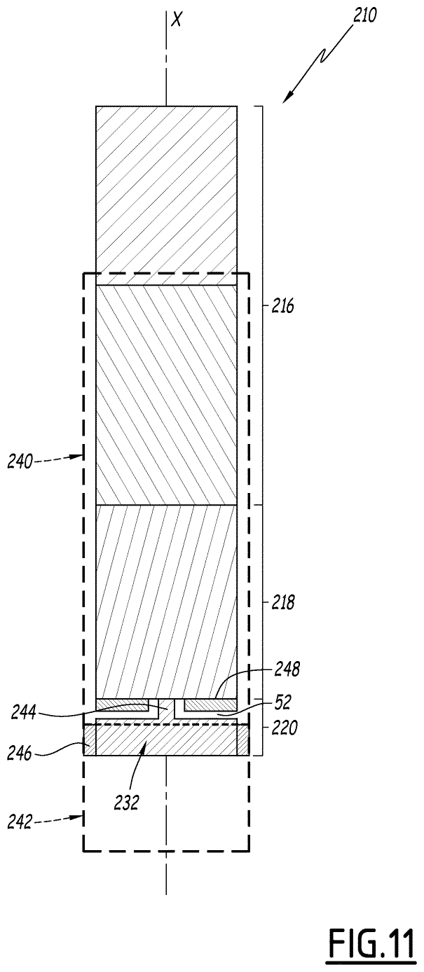

With reference to FIG. 11, the tobacco article 210 may present an air inlet area 240 and a stick identification area 242. The air inlet area 240 may comprise for example at least part of the mouth end portion 216 and furthermore comprise the tobacco portion 218. The stick identification area 242 may comprise at least part of the solid stop 232. In particular, the stick identification area 242 may form an airflow barrier, along the article axis X, i.e. in particular no airflow may pass from one end of the stick identification area 242 to the opposite end of the stick identification area 242, the ends being defined along a direction parallel to the article axis X.

Still with reference to FIG. 11, according to an example, a part 244 of the solid stop 232 may protrude from the stick identification area 242 into the air inlet area 240. The air inlet area 240 may comprise a part of the solid stop 232 forming the airflow channel(s) 52, for example in form of an L. The stick identification area 242 may comprise a part of the solid stop 232 comprising the identification element 40 and/or the sensor 42, not shown in FIG. 11.

According to an example, the solid stop 232 may comprise at least one seal 246 configured to prevent vapour and/or an airflow from penetrating into the stick identification area 242, for example along a direction perpendicular to the article axis X. According to an example, the seal 246 may extend circumferentially around the part of the solid stop 232, which comprises the identification element 40 and/or the sensor 42.

According to an example, the tobacco article 210 may comprise an absorbent material, in particular configured of letting the airflow pass, and further configured for capturing or absorbing at least partially aerosol from vapour, such as air comprising aerosol, for example from the tobacco portion 218. The absorbent material may for example be arranged between the tobacco portion 218 and the solid stop 232, for example in form of a layer 248 extending perpendicularly to the article axis X. This allows in particular preventing vapour, such as air comprising aerosol, to pass from the tobacco portion 218 into the upstream end portion 220, and allows thus to protect the identification element 40 and/or the sensor 42 of the solid stop 232 from aerosol.

According to an example, the airflow channel(s) 52 may be filled at least partially with the absorbent material. According to an alternative example, the airflow channel(s) 52 may be empty, i.e. filled with ambient air only.

Although some features above are described with reference to FIG. 11 as an example of the third embodiment, at least one feature, preferably all of these features, may be combined alternatively with the tobacco article 10, 110 according to the first or the second embodiment.

1. A tobacco article designed to operate with an aerosol generating device and extending along an article axis between a mouth end and an upstream end and comprising:
a mouth end portion defining the mouth end;
a tobacco portion arranged between the upstream end and the mouth end portion; and
an upstream end portion arranged adjacent to the tobacco portion and defining the upstream end of the tobacco article;
the upstream end portion comprising a solid stop extending transversally in respect with the article axis;
the solid stop comprising an identification element and/or a sensor configured to provide data usable by the aerosol generating device to carry out or alter at least one of the aerosol generating device's functionalities.

2. The tobacco article according to claim 1, wherein the solid stop is air impermeable according to the article axis.

3. The tobacco article according to claim 1, wherein the solid stop delimits at least one airflow channel defining an airflow outlet opening to the tobacco portion.

4. The tobacco article according to claim 3, wherein the airflow outlet is arranged on a contacting face of the solid stop, said contacting face being in contact with the tobacco portion and extending transversally in respect with the article axis.

5. The tobacco article according to claim 3, wherein the at least one airflow channel defines at least one airflow inlet arranged on a lateral face of the solid stop, said lateral face extending according to the article axis.

6. The tobacco article according to claim 3, wherein the at least one airflow channel defines a plurality of airflow inlets arranged circumferentially on a lateral face of the solid stop, said lateral face extending according to the article axis.

7. The tobacco article according to claim 1, further comprising a wrapper wrapping at least the tobacco portion and extending around the article axis.

8. The tobacco article according to claim 7, wherein the wrapper defines at least one airflow inlet opening to the tobacco portion.

9. The tobacco article according to claim 7, wherein the wrapper wraps the tobacco portion and the upstream end portion together.

10. The tobacco article according to claim 1, wherein the solid stop comprises an identification element configured to provide identification data and/or authentication data relative to the tobacco article.

11. The tobacco article according to claim 10, wherein the identification element is arranged on an external face of the solid stop, the external face extending transversally in respect with the article axis.

12. The tobacco article according to claim 11, wherein the identification element is at least one of:
antenna/spool;
RFID tag;
optical code;
flat symbol; or
embossed symbol.

13. The tobacco article according to claim 1, wherein the tobacco portion further comprises a heating element arranged in contact with the solid stop.

14. The tobacco article according to claim 1, wherein the solid stop comprises a temperature sensor configured to provide temperature measurements of least a part of the tobacco portion.

15. An assembly comprising:
the tobacco article according to claim 1, and
an aerosol generating device delimiting a cavity configured for receiving the tobacco article.

16. The tobacco article according to claim 3, wherein the tobacco article comprises an absorbent material configured for absorbing at least partially aerosol from air comprising aerosol.

17. The tobacco article according to claim 7, wherein the wrapper defining a plurality of airflow inlets arranged circumferentially and opening to the tobacco portion.

18. The tobacco article according to claim 13, wherein the heating element is a susceptor.
